(19) United States
(12) Patent Application Publication
(10) Pub. No.: US 2026/0091776 A1
(43) Pub. Date: Apr. 2, 2026

(54) DECELERATION ASSIST DEVICE, DECELERATION ASSIST METHOD, AND STORAGE MEDIUM

(71) Applicant: TOYOTA JIDOSHA KABUSHIKI KAISHA, Toyota-shi (JP)

(72) Inventor: Tatsuya NISHIMOTO, Susono-shi (JP)

(73) Assignee: TOYOTA JIDOSHA KABUSHIKI KAISHA, Toyota-shi (JP)

(21) Appl. No.: 19/211,744

(22) Filed: May 19, 2025

(30) Foreign Application Priority Data
Sep. 27, 2024 (JP) 2024-168138

(51) Int. Cl. B60W 30/045

(52) U.S. Cl. CPC B60W 30/045; B60W 2552/30; B60W 2556/40; B60W 2720/106

(57) ABSTRACT

A deceleration assist device for performing deceleration assist control for decelerating a vehicle when a curved road is detected in front of a traveling vehicle, the deceleration assist device acquires first road shape information including a road shape in front of the vehicle on the basis of a detection result of a position information detection device for detecting position information of the vehicle and a map database, and acquires second road shape information including a road shape in front of the vehicle on the basis of a recognition result of a front recognition sensor for recognizing the front of the vehicle mounted on the vehicle, and performs deceleration assist control on the basis of the second road shape information when the first road shape information and the second road shape information do not match.

### CROSS-REFERENCE TO RELATED APPLICATION

This application claims priority to Japanese Patent Application No. 2024-168138 filed on Sep. 27, 2024. The disclosure of the above-identified application, including the specification, drawings, and claims, is incorporated by reference herein in its entirety.

### BACKGROUND

### 1. Technical Field

The present disclosure relates to a deceleration assist device, a deceleration assist method, and a storage medium.

### 2. Description of Related Art

On occasions, road curve information acquired based on road information from a navigation device is not consistent with actual road curve information calculated from a turning motion parameter that represents the vehicle behavior detected by sensors. Japanese Unexamined Patent Application Publication No. 2002-329299 (JP 2002-329299 A) discloses a device that, on such occasions, determines that the road information obtained from the navigation device is unreliable and suspends a control command for deceleration assist, etc.

### SUMMARY

The device described in JP 2002-329299 A determines consistency using a turning motion parameter for the vehicle obtained from the detection result from the sensors. Therefore, a consistency determination process cannot be performed before the vehicle actually reaches a curved road. That is, there is an issue that the determination result cannot be effectively reflected in the deceleration assist or the like started before the vehicle reaches a curved road.

The present disclosure provides a technique of effectively improving the accuracy of deceleration assist control.

An aspect of the present disclosure provides
a deceleration assist device that performs deceleration assist control for decelerating a vehicle when a curved road is detected ahead of the vehicle while traveling, the deceleration assist device being configured to:
acquire first road shape information including a road shape ahead of the vehicle based on a detection result from a position information detection device that detects position information on the vehicle and a map database, and acquire second road shape information including a road shape ahead of the vehicle based on a recognition result from a front recognition sensor mounted on the vehicle to recognize a scene ahead of the vehicle; and perform the deceleration assist control based on the second road shape information when the first road shape information and the second road shape information do not coincide with each other.

An aspect of the present disclosure provides
a deceleration assist method of performing deceleration assist control for decelerating a vehicle when a curved road is detected ahead of the vehicle while traveling, the deceleration assist method including:
acquiring first road shape information including a road shape ahead of the vehicle based on a detection result from a position information detection device that detects position information on the vehicle and a map database, and acquiring second road shape information including a road shape ahead of the vehicle based on a recognition result from a front recognition sensor mounted on the vehicle to recognize a scene ahead of the vehicle; and performing the deceleration assist control based on the second road shape information when the first road shape information and the second road shape information do not coincide with each other.

An aspect of the present disclosure provides
a storage medium storing a program that causes a computer of a deceleration assist device that performs deceleration assist control for decelerating a vehicle when a curved road is detected ahead of the vehicle while traveling to execute a process including:
acquiring first road shape information including a road shape ahead of the vehicle based on a detection result from a position information detection device that detects position information on the vehicle and a map database, and acquiring second road shape information including a road shape ahead of the vehicle based on a recognition result from a front recognition sensor mounted on the vehicle to recognize a scene ahead of the vehicle; and performing the deceleration assist control based on the second road shape information when the first road shape information and the second road shape information do not coincide with each other.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a hardware configuration of a vehicle according to the present embodiment;

FIG. 2 is a schematic diagram illustrating a software configuration of the control device according to the present embodiment;

FIG. 3 is a table for describing a process of determining whether or not the deceleration assist control according to the present embodiment can be executed; and

FIG. 4 is a flowchart illustrating a determination process of whether or not the deceleration assist control according to the present embodiment can be executed.

### DETAILED DESCRIPTION OF EMBODIMENTS

Hereinafter, a deceleration assist device, a deceleration assist method, and a storage medium according to the present embodiment will be described with reference to the drawings.

### Hardware Configuration

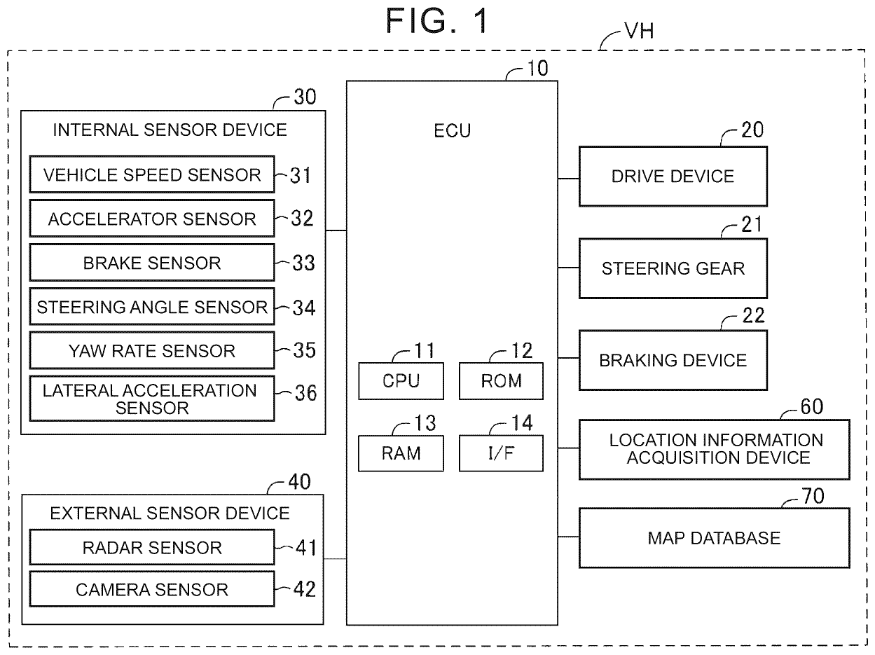

FIG. 1 is a schematic diagram illustrating a hardware configuration of a vehicle VH according to the present embodiment. In the following description, the vehicle VH may be referred to as an own vehicle when it needs to be distinguished from other vehicles or the like.

The vehicle VH has ECU (Electronic Control Unit) 10. ECU 10 includes CPU (Central Processing Unit) 11, ROM (Read Only Memory) 12, RAM (Random Access Memory) 13, and interface device 14. CPU 11 is a processor that executes various programs stored in ROM 12 (storage medium). ROM 12 is a non-volatile memory that stores data and the like required for CPU 11 to execute various programs. RAM 13 provides a working area to be deployed when various programs are executed by CPU 11. The interface device 14 is a communication device for communicating with an external device.

ECU 10 is a central device for assisting the driving of the vehicle VH. Driving assistance is a concept including automatic driving. In the present embodiment, ECU 10 performs deceleration assistance (Deceleration Assist: DA) control for assisting the driver in decelerating the vehicle VH. Details of the deceleration assist control will be described later. A drive device 20, a steering device 21, a braking device 22, an internal sensor device 30, an external sensor device 40, a position information detection device 60, a map database 70, and the like are communicably connected to ECU 10.

The drive device 20 generates a driving force to be transmitted to the driving wheels of the vehicle VH. Examples of the drive device 20 include an electric motor and an engine. In the present embodiment, the vehicle VH may be any of a hybrid electric vehicle (HEV), a plug-in Hybrid vehicle (PHEV), a fuel cell electric vehicle (FCEV, a battery electric vehicle (BEV), and an engine-driven vehicle. The steering device 21 applies a steering force to the wheels of the vehicle VH. The braking device 22 applies a braking force to the wheels of the vehicle VH.

The internal sensor device 30 is a sensor or the like that acquires the traveling condition of the vehicle VH. The internal sensor device 30 includes a vehicle speed sensor 31, an accelerator sensor 32, a brake sensor 33, a steering angle sensor 34, a yaw rate sensor 35, a lateral acceleration sensor 36, and the like.

The vehicle speed sensor 31 detects a traveling speed (vehicle speed) of the vehicle VH. The accelerator sensor 32 detects an operation amount of an accelerator pedal (not shown) by a driver. The brake sensor 33 detects an operation amount of a brake pedal (not shown) by the driver. The steering angle sensor 34 detects a rotation angle (steering angle) of a steering wheel or a steering shaft (not shown). The yaw rate sensor 35 detects the yaw rate of the vehicle VH. The lateral acceleration sensor 36 detects a lateral acceleration that is acceleration in the vehicle width-direction of the vehicle VH. The internal sensor device 30 transmits the traveling condition of the vehicle VH detected by the sensors 31 to 36 to ECU 10 at a predetermined cycle.

The external sensor device 40 (an exemplary front recognition sensor of the present disclosure) is a sensor that recognizes a target object related to a target object around a vehicle VH. The external sensor device 40 includes a radar sensor 41, a camera sensor 42, and the like. Examples of the target information include a surrounding vehicle, a shape of a road, a white line of a road, and a road sign.

The radar sensor 41 detects a target that is present around the vehicle VH. The radar sensor 41 includes a millimeter wave radar and/or a lidar. Millimeter-wave radar radiates radio waves in the millimeter-wave band and receives millimeter waves reflected by targets present in the radiation range. The millimeter wave radar acquires the relative distance, the relative velocity, and the like between the vehicle VH and the target on the basis of the phase difference between the transmitted millimeter wave and the received reflected wave, the attenuation level of the reflected wave, the time from the transmission of the millimeter wave to the reception of the reflected wave, and the like. The lidar sequentially scans the pulsed laser light having a wavelength shorter than the millimeter wave toward a plurality of directions, and receives the reflected light reflected by the target, thereby acquiring the shapes of the targets detected around the vehicle VH, the relative distances between the vehicle VH and the targets, the relative velocities, and the like.

The camera sensor 42 captures an image of the surroundings of the vehicle VH and processes the captured image-data to acquire target object information around the vehicle VH. As the camera sensor 42, for example, a digital camera having an image sensor such as a CMOS or a CCD can be used. The target information is information indicating a type of a target detected around the vehicle VH, a relative distance between the vehicle VH and the target, a relative velocity, and the like. The type of the target may be recognized by machine learning such as pattern matching, for example.

The external sensor device 40 repeatedly transmits the acquired target object data to ECU 10 every time a predetermined period elapses. Note that the external sensor device 40 does not necessarily have to include both the radar sensor 41 and the camera sensor 42, and may include, for example, only the camera sensor 42.

The position information detection device 60 detects the present position information of the vehicle VH. As the position information detection device 60, for example, a GPS (Global Positioning System), a GNSS (Global Navigation Satellite System) or the like which is provided in a navigation system (not shown) can be used. The position information detection device 60 transmits the detected present position information of the vehicle VH to ECU 10 at a predetermined cycle.

The map database 70 is, for example, a database of map information included in the navigation system, and is stored in a storage device (a hard disk, a flash memory, or the like) of the vehicle VH. The map information includes, for example, information indicating a shape of a road, such as a radius of curvature of a curved road. The map database 70 may be stored in an external server capable of communicating with the vehicle VH. In this case, VH may acquire the map-information from the external servers through a communication device (not shown).

### Software Configuration

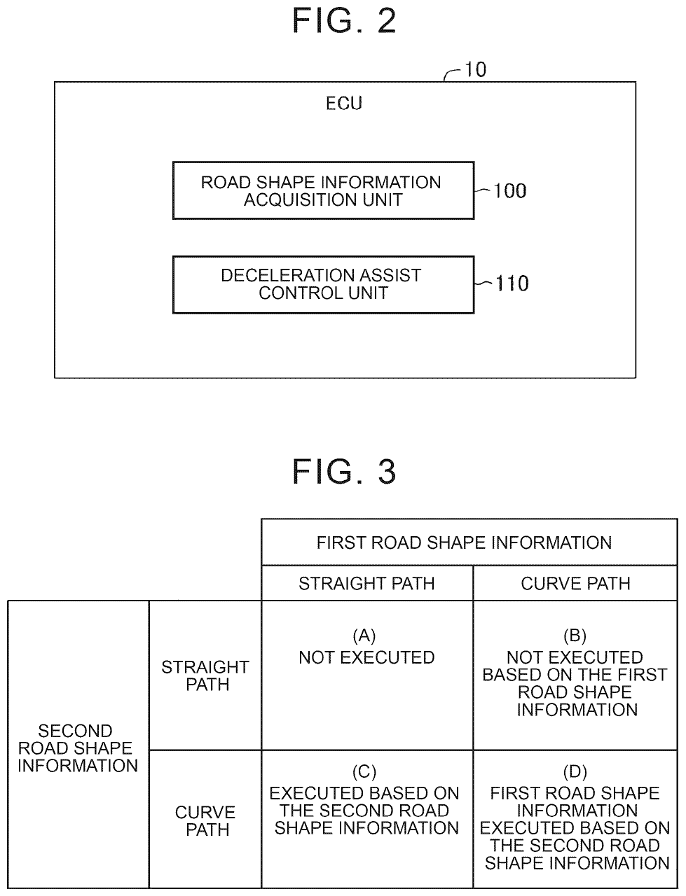

FIG. 2 is a schematic diagram illustrating a software configuration of the control device according to the present embodiment.

As illustrated in FIG. 2, ECU 10 includes a road-shape-information acquisition unit 100, a deceleration assist control unit 110, and the like as functional elements. The respective functional elements 100,110 are realized by CPU 11 of ECU 10 reading a program stored in ROM 12 into a RAM 13 and executing the program. Note that all or a part of the functional elements 100,110 may be provided in another ECU separate from ECU 10 or in an information processing device of a facility (e.g., a control center) capable of communicating with the vehicle VH.

The road shape information acquisition unit 100 acquires road shape information (for example, curvature of a curved road, distance to a curved road, and the like) representing the shape of the road ahead of the vehicle VH, based on the present position information of the vehicle VH detected by the position information detection device 60 and the map database 70. Hereinafter, the road shape information acquired based on the map database 70 is referred to as “first road shape information”. Further, the road shape information acquisition unit 100 acquires road shape information (for example, curvature of a curved road) representing the shape of the road ahead of the vehicle VH, based on the detection result of the external sensor device 40. Hereinafter, the road shape information acquired based on the detection result of the external sensor device 40 is referred to as “second road shape information”. Further, the road shape information acquisition unit 100 acquires road shape information (for example, curvature of a curved road) representing a shape of a road on which the vehicle VH is traveling, based on turning parameters (steering angle, yaw rate, lateral acceleration, and the like) of the vehicle VH detected by the internal sensor device 30. Hereinafter, the road shape information acquired based on the internal sensor device 30 is referred to as “third road shape information”. The road shape information acquisition unit 100 sequentially transmits the acquired first road shape information, second road shape information, and third road shape information to the deceleration assist control unit 110.

When the deceleration target is detected in front of the traveling vehicle VH, the deceleration assist control unit 110 executes deceleration assist control for assisting the deceleration operation of the driver of the vehicle VH. Examples of the deceleration target include a curved road existing in front of the vehicle VH during traveling, a preceding vehicle traveling in front of the host vehicle VH, and an interruption vehicle attempting to interrupt the vehicle ahead of the host vehicle VH in the host lane from an adjoining lane. In the following, deceleration assist control when a curved road is detected in front of a vehicle VH as a deceleration target will be described.

The deceleration assist control unit 110 determines whether or not deceleration is required when the vehicle VH travels on the curved road detected in front of the vehicle VH at the present vehicle speed. When it is determined that deceleration is required, the deceleration assist control unit 110 executes deceleration assist control for decelerating the vehicle VH at a desired deceleration. Specifically, the deceleration assist control unit 110 may detect a curved road ahead of the vehicle VH based on the road shape information transmitted from the road shape information acquisition unit 100. In this case, the deceleration assist control unit 110 calculates a vehicle speed (hereinafter, referred to as an appropriate vehicle speed) suitable for the vehicle VH to travel on the curved road, based on the curvature of the curved road or the like. The deceleration assist control unit 110 determines that deceleration is necessary when the current vehicle speed detected by the vehicle speed sensor 31 is higher than the proper vehicle speed. When it is determined that deceleration is necessary, the deceleration assist control unit 110 calculates a deceleration necessary to decelerate the vehicle VH to the optimum vehicle speed on the basis of each of the first road shape information, the second road shape information, and the third road shape information. Hereinafter, the necessary deceleration calculated based on the first road shape information is referred to as “first necessary deceleration”, the necessary deceleration calculated based on the second road shape information is referred to as “second necessary deceleration”, and the necessary deceleration calculated based on the third road shape information is referred to as “third necessary deceleration”.

When the first necessary deceleration, the second necessary deceleration, and the third necessary deceleration are respectively calculated, the deceleration assist control unit 110 sets the deceleration having the largest absolute value among them to the target deceleration. When the target deceleration is set, the deceleration assist control unit 110 controls the operation of the braking device 22 based on the set target deceleration. Thus, the deceleration assist control for decelerating the vehicle VH to an appropriate vehicle speed suitable for traveling on the curved road is realized.

The first road shape information is information acquired based on the position information detection device 60 and the map database 70 in the deceleration assist control. The second road shape information is information acquired based on the external sensor device 40. By using the first road shape information and the second road shape information, it is possible to improve the performance by increasing the accuracy of the deceleration assist control. However, there is an effect of an error in the present position of the host-vehicle VH detected by the position information detection device 60, a linear improvement of the roadway due to construction, or the like. Due to this effect, the road shape acquired based on the map database 70 may differ from the road shape that the vehicle VH actually intends to travel. In such a situation, when the deceleration assist control is performed using the first road shape information acquired based on the map database 70, the deceleration assist becomes unnecessary operation, which causes performance degradation.

Therefore, even if the road ahead of the vehicle VH recognized based on the first road shape information is a curved road, the deceleration assist control unit 110 of the present embodiment suppresses the execution of the deceleration assist control when the road ahead of the vehicle VH recognized based on the second road shape information is not a curved road, that is, when the external sensor device 40 recognizes the road ahead of the vehicle VH as a straight road.

FIG. 3 is a table for explaining a process of determining whether or not to execute the deceleration assist control according to the present embodiment. In the table in FIG. 3, a vertical item indicates a recognition result based on the external sensor device 40, and a horizontal item indicates a recognition result based on the position information detection device 60 and the map database 70.
(A) shown in FIG. 3, the road ahead of the vehicle VH recognized based on the first road shape information acquired from the position information detection device 60 and the map database 70 is a straight road, and the road ahead of the vehicle VH recognized based on the second road shape information acquired from the detection result of the external sensor device 40 is also a straight road. In this case, the deceleration assist control unit 110 does not perform the deceleration assist control because it does not detect the curve path as the deceleration target.
(D) shown in FIG. 3 is when the road ahead of the vehicle VH recognized based on the first road shape information acquired from the position information detection device 60 and the map database 70 is a curved road, and the road ahead of the vehicle VH recognized based on the second road shape information acquired from the detection result of the external sensor device 40 is also a curved road. In this case, the deceleration assist control unit 110 performs the deceleration assist control based on the first road shape information and the second road shape information acquired by the road shape information acquisition unit 100. That is, both the first road shape information and the second road shape information are used for the deceleration assist control. This makes it possible to effectively improve the accuracy of the deceleration assist control.
(C) shown in FIG. 3 is when the road ahead of the vehicle VH recognized based on the first road shape information acquired from the position information detection device 60 and the map database 70 is a straight road, and the road ahead of the vehicle VH recognized based on the second road shape information acquired from the detection result of the external sensor device 40 is a curved road. In this case, the deceleration assist control unit 110 performs the deceleration assist control using the second road shape information acquired based on the detection result of the external sensor device 40. Accordingly, the deceleration assist control can be started from a timing earlier than the timing prior to recognizing the curve path ahead of the vehicle VH based on the position information detection device 60 and the map-database 70.
(B) shown in FIG. 3, the road ahead of the vehicle VH recognized based on the first road shape information acquired from the position information detection device 60 and the map database 70 is a curved road, and the road ahead of the vehicle VH recognized based on the second road shape information acquired from the detection result of the external sensor device 40 is a straight road. In this case, the deceleration assist control unit 110 does not perform the deceleration assist control. That is, the execution of the deceleration assist control based on the first road shape information acquired by the position information detection device 60 and the map database 70 is suppressed. This makes it possible to effectively suppress unnecessary operation of the deceleration assist control in a case where the road shape recognized from the map database 70 is different from the actual road shape.

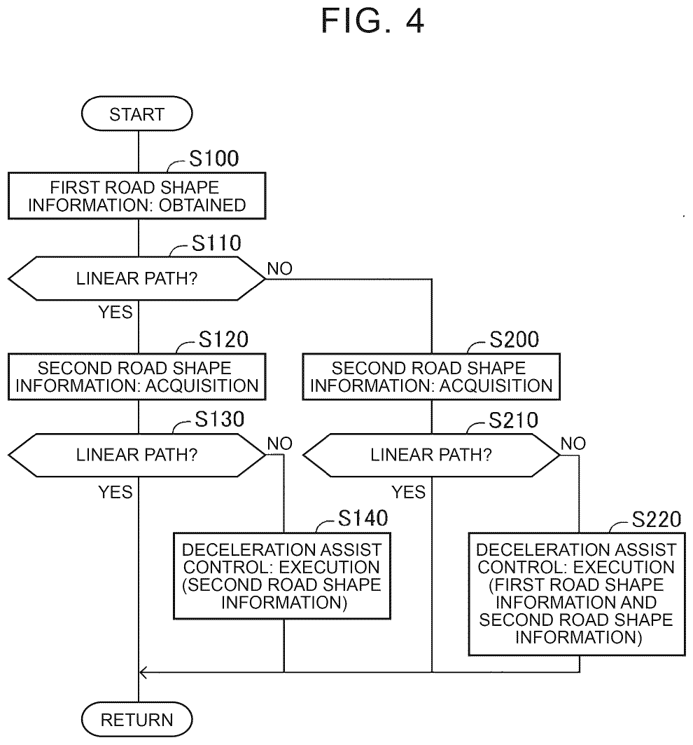

FIG. 4 is a flow chart for explaining a process of determining whether or not to execute the deceleration assist control by ECU 10. Details of specific processing of the deceleration assist control itself, such as determination of whether or not deceleration is necessary, setting of a target deceleration, and operation control of the braking device 22, are known, and therefore, description thereof will be omitted in the flowchart shown in FIG. 4. The routine illustrated in FIG. 4 is started by, for example, traveling of the vehicle VH.

In S100, ECU 10 acquires the first road-shape information in front of the vehicle VH based on the position information detection device 60 and the map database 70. Then, in S110, ECU 10 determines whether the road ahead of the vehicle VH is a straight road based on the first road configuration information. When it is determined that the road ahead of the vehicle VH is a straight road (Yes), ECU 10 proceeds to S120 process. On the other hand, when the road ahead of the vehicle VH is not determined as a straight road (No), that is, when the road is recognized as a curved road, ECU 10 proceeds to S200 process.

In S120, ECU 10 acquires the second road shape information in front of the vehicle VH based on the detection result of the external sensor device 40. Then, in S130, ECU 10 determines whether the road ahead of the vehicle VH is a straight road based on the second road configuration information. When S130 determines that the road ahead of the vehicle VH is a straight road (Yes), the road ahead of the vehicle VH recognized based on the first road shape information and the second road shape information is a straight road. ECU 10 then returns the routine without implementing deceleration assist control.

On the other hand, when S130 does not determine that the road in front of the vehicle VH is a straight road (No), that is, when the road is recognized as a curved road, ECU 10 proceeds to S140 process. In S140, the deceleration assist control is performed using the second road shape information acquired based on the detection result of the external sensor device 40, and then the routine is returned.

In S200, ECU 10 acquires the second road shape information in front of the vehicle VH based on the detection result of the external sensor device 40. Then, in S210, ECU 10 determines whether the road ahead of the vehicle VH is a straight road based on the second road configuration information. In S210, when it is determined that the road ahead of the vehicle VH is a straight road (Yes), the road ahead of the vehicle VH recognized based on the first road shape information is a curved road, and the road ahead of the vehicle VH recognized based on the second road shape information is a straight road. ECU 10 then returns the routine without implementing deceleration assist control.

On the other hand, when S210 does not determine that the road in front of the vehicle VH is a straight road (No), that is, when the road is recognized as a curved road, ECU 10 proceeds to S220 process. In S220, the deceleration assist control is performed using the first road shape information acquired based on the position information detection device 60 and the map database 70 and the second road shape information acquired based on the detection result of the external sensor device 40. S220 then returns the routine.

Although the deceleration assist device, the deceleration assist method, and the storage medium according to the present embodiment have been described above, the present disclosure is not limited to the above-described embodiment, and various modifications can be made without departing from the object of the present disclosure.

For example, in the above embodiment, the deceleration assist control is performed during manual driving by drivers of the vehicle VH. However, the disclosed technique can also be applied to deceleration control in which the vehicle VH is decelerated along the curve path while the following vehicle-to-vehicle distance control (ACC) is being executed. The present disclosure can also be applied to an autonomous vehicle that automatically performs some or all of the driving operations.

What is claimed is:

1. A deceleration assist device that performs deceleration assist control for decelerating a vehicle when a curved road is detected ahead of the vehicle while traveling, the deceleration assist device being configured to:
acquire first road shape information including a road shape ahead of the vehicle based on a detection result from a position information detection device that detects position information on the vehicle and a map database, and acquire second road shape information including a road shape ahead of the vehicle based on a recognition result from a front recognition sensor mounted on the vehicle to recognize a scene ahead of the vehicle; and
perform the deceleration assist control based on the second road shape information when the first road shape information and the second road shape information do not coincide with each other.

2. The deceleration assist device according to claim 1, wherein the deceleration assist control is performed based on both the first road shape information and the second road shape information when the first road shape information and the second road shape information coincide with each other.

3. The deceleration assist device according to claim 1, wherein the deceleration assist control is not performed when a curved road is not recognized ahead of the vehicle as the second road shape information, even when a curved road is recognized ahead of the vehicle as the first road shape information.

4. A deceleration assist method of performing deceleration assist control for decelerating a vehicle when a curved road is detected ahead of the vehicle while traveling, the deceleration assist method comprising:
acquiring first road shape information including a road shape ahead of the vehicle based on a detection result from a position information detection device that detects position information on the vehicle and a map database, and acquiring second road shape information including a road shape ahead of the vehicle based on a recognition result from a front recognition sensor mounted on the vehicle to recognize a scene ahead of the vehicle; and
performing the deceleration assist control based on the second road shape information when the first road shape information and the second road shape information do not coincide with each other.

5. A non-transitory storage medium storing a program that causes a computer of a deceleration assist device that performs deceleration assist control for decelerating a vehicle when a curved road is detected ahead of the vehicle while traveling to execute a process comprising:
acquiring first road shape information including a road shape ahead of the vehicle based on a detection result from a position information detection device that detects position information on the vehicle and a map database, and acquiring second road shape information including a road shape ahead of the vehicle based on a recognition result from a front recognition sensor mounted on the vehicle to recognize a scene ahead of the vehicle; and
performing the deceleration assist control based on the second road shape information when the first road shape information and the second road shape information do not coincide with each other.
